(19) United States
(12) Patent Application Publication
(10) Pub. No.: US 2024/0414686 A1
(43) Pub. Date: Dec. 12, 2024

(54) NETWORK NODE, INFORMATION PROCESSING SYSTEM, INFORMATION PROCESSING METHOD, AND NON-TRANSITORY STORAGE MEDIUM

(71) Applicant: TOYOTA JIDOSHA KABUSHIKI KAISHA, Toyota-shi (JP)

(72) Inventors: Kazuya OKADA, Tokyo (JP); Jing MA, Yokohama-shi (JP); Naoya KANEKO, Tokyo (JP); Xiao SHAO, Kawasaki-shi (JP); Takuya ASAOKA, Tokyo (JP)

(73) Assignee: TOYOTA JIDOSHA KABUSHIKI KAISHA, Toyota-shi (JP)

(21) Appl. No.: 18/736,271

(22) Filed: Jun. 6, 2024

(30) Foreign Application Priority Data
Jun. 12, 2023 (JP) 2023-096573

(51) Int. Cl. H04W 64/00; G01S 11/02; H04L 5/00

(52) U.S. Cl. CPC H04W 64/003; G01S 11/02; H04L 5/0048

(57) ABSTRACT

A network node that forms a wireless communication network is configured to: receive an inquiry request for location information of a user terminal (UE); and transmit a response including the location information of the user terminal in response to the inquiry request. The location information included in the response is expressed by a bit string based on a space-filling curve.

### CROSS-REFERENCE TO RELATED APPLICATION

This application claims priority to Japanese Patent Application No. 2023-096573 filed on Jun. 12, 2023, incorporated herein by reference in its entirety.

### BACKGROUND

### 1. Technical Field

The present disclosure relates to a network node, an information processing system, an information processing method, and a non-transitory storage medium.

### 2. Description of Related Art

Japanese Unexamined Patent Application Publication No. 2020-13539 (JP 2020-13539 A) discloses that spatiotemporal information is converted and divided into one-dimensional bit strings, and a forward bit string of a converted one-dimensional bit string is stored in at least a key, and then a backward bit string and corresponding data are stored in a value of the key in a storage destination node. Further, J P 2020-13539 A discloses that a range condition of spatiotemporal information to be searched is converted and divided into a one-dimensional bit string, and a key is searched from a search destination node using at least divided forward bits, and then a value corresponding to a divided backward bit string is searched from a value of the searched key, and corresponding data included in the searched value is output as a search result.

### SUMMARY

One aspect of the present disclosure provides a technique for easily determining whether a user terminal is included in a designated location or area.

A first aspect of the disclosure relates to a network node that forms a wireless communication network, the network node including a processor. The processor is configured to receive an inquiry request for location information of a user terminal (UE) and transmit a response including the location information of the user terminal in response to the inquiry request. The location information included in the response is expressed by a bit string based on a space-filling curve.

In the first aspect, the location information included in the response may be expressed by a bit string based on a Hilbert curve or a Z-order curve.

In the first aspect, the location information included in the response may represent an area and have the number of bits depending on size of the area.

In the first aspect, the location information included in the response may be expressed by a bit string in which a first bit string specifying a first direction and a second bit string specifying a second direction are alternately arranged.

In the first aspect, the processor may be configured to acquire location information from the user terminal and store the location information of the user terminal in a bit string format based on a space-filling curve.

In the first aspect, the inquiry request may include a request for confirmation as to whether the user terminal is located in a predetermined area, the response may include information as to whether the user terminal is located in the predetermined area, and the processor may be configured to confirm whether the user terminal is located in the predetermined area by comparing a bit string based on a space-filling curve representing the predetermined area with the stored bit string based on a space-filling curve.

In the first aspect, the predetermined area may be expressed as a bit string based on a space-filling curve in the inquiry request, and whether the user terminal is located in the predetermined area may be confirmed by comparing a bit string included in the inquiry request with the stored bit string.

In the first aspect, the predetermined area may be an area that combines a plurality of rectangles, and the inquiry request may include a bit string expressing each of the rectangles based on a space-filling curve.

In the first aspect, the predetermined area may be expressed in a latitude/longitude format or a Geographical Area Description (GAD) format in the inquiry request, and the processor may be configured to convert a predetermined area included in the inquiry request into a bit string based on a space-filling curve.

A second aspect of the disclosure relates to an information processing system including a network node, and a client. The client is configured to transmit an inquiry request for location information of a user terminal to the network node, the network node is configured to transmit a response including the location information of the user terminal to the client in response to the inquiry request, and the location information included in the response is expressed by a bit string based on a space-filling curve.

In the second aspect, the location information included in the response may be expressed by a bit string based on a Hilbert curve or a Z-order curve.

In the second aspect, the client may be configured to determine whether the user terminal is located in a predetermined area by comparing a bit string based on a space-filling curve included in the response with a bit string that expresses the predetermined area based on a space-filling curve.

A third aspect of the disclosure relates to an information processing method that is executed by a network node forming a wireless communication network. The information processing method includes receiving an inquiry request for location information of a user terminal (UE) and transmitting a response including the location information of the user terminal in response to the inquiry request. The location information included in the response is expressed by a bit string based on a space-filling curve.

A fourth aspect of the disclosure relates to a non-transitory storage medium storing instructions that are executable by one or more processors in a computer and that cause the one or more processors to perform the information processing method according to the third aspect.

With the first aspect, the second aspect, the third aspect, and the fourth aspect of the present disclosure, it is possible to easily determine whether a user terminal is included in a designated location or area.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram exemplifying components of a wireless communication system;

FIG. 2 is a diagram exemplifying components of a wireless communication system;

FIG. 3A is a diagram illustrating a configuration example of an information processing device that can operate as an NF, an OAM terminal, or an external server;

FIG. 3B is a diagram illustrating a configuration example of an information processing device that can operate as a user terminal;

FIG. 4 is a sequence diagram regarding a location service;

FIG. 5A is a diagram illustrating a code expression of location information based on a space-filling curve;

FIG. 5B is a diagram illustrating a code expression of location information based on a space-filling curve;

FIG. 6 is a flowchart illustrating a flow of processing for a location inquiry request;

FIG. 7 is a flowchart illustrating a flow of UE location information acquisition and storage processing; and

FIG. 8 is a diagram illustrating designating an area of an arbitrary shape using a code expression based on a space-filling curve.

### DETAILED DESCRIPTION OF EMBODIMENTS

### Overview

TS 29.572, a 3GPP standard, defines a mechanism when providing services according to User Equipment (UE) in Location Service (location service). In the Location Service, an interface is defined for inquiring the location information of the UE to the Location Management Function (LMF).

Here, TS 23.032 specifies an expression format called Geographical Area Description (GAD) for expressing the location information used in the inquiry response. In GAD, information on latitude and longitude is directly expressed by a location (point), and an area is expressed by listing a plurality of points that collectively form the area.

When the location information of the UE is used, for example, there are cases where it is desired to determine whether the UE location is included in a specific area. However, when the area and UE location are expressed in the GAD format, processing for the determination becomes complicated.

The present disclosure is to provide a technology that allows easy determination of whether UE is included in a designated location or area.

A first aspect of the present disclosure relates to a network node that forms a wireless communication network, the network node including a processor configured to receive an inquiry request for location information of a user terminal (UE), and transmit a response including location information of the user terminal in response to the inquiry request, where the location information included in the response is expressed by a bit string based on a space-filling curve.

“Location” in the present disclosure is a concept that includes a point and an area of an arbitrarily shape. The point may include a predetermined uncertainty, and the uncertainty may be, for example, a circle, an ellipse, or a rectangle. Examples of areas of arbitrarily shapes may be polygons (including arbitrary quadrilaterals such as rectangles, parallelograms, and trapezoids, as well as triangles and polygons larger than pentagons), circles, ellipses, and combinations of at least some of these. In the present disclosure, at least either information representing the location or information related to the location corresponds to “location information”.

In this aspect, since the network node transmits location information expressed as a bit string based on a space-filling curve, a node (which may also be referred to as a client) that receives this information can easily determine whether the UE is included in an area expressed in a similar format.

The space-filling curve in this aspect can be, for example, a Hilbert curve or a Z-order curve. Therefore, the location information included in the response can be expressed by a bit string based on a Hilbert curve or a Z-order curve.

In this aspect, the location information included in the response may represent an area and have the number of bits depending on size of the area. Typically, the wider the area, the shorter the number of bits will be used to express the location information, and the narrower the area, the longer the number of bits will be used to express the location information.

In this aspect, the location information included in the response may be expressed by a bit string in which a first bit string specifying a first direction and a second bit string specifying a second direction are alternately arranged by a predetermined number of bits (for example, 1 bit at a time). Here, the first direction and the second direction are different directions, and as an example, the first direction and the second direction are orthogonal to each other. For example, the first direction may be a latitude direction and the second direction may be a longitude direction.

The network node in this aspect may further acquire location information from the user terminal and store the location information of the user terminal in a bit string format based on a space-filling curve. Here, the network node may acquire location information in the bit string format based on the space-filling curve from the user terminal. Alternatively, the network node may acquire a bit string expressed in other formats (for example, latitude/longitude format or GAD format) from the user terminal and convert the acquired location information into a bit string format based on a space-filling curve.

In this aspect, the inquiry request may include a request for confirmation as to whether the user terminal is located in a predetermined area, and the response may include information as to whether the user terminal is located in the predetermined area, and further the processor may further perform confirmation on whether the user terminal is located in the predetermined area by comparing a bit string based on the space-filling curve representing the predetermined area and a bit string based on the stored space-filling curve.

With such a configuration, the network node can return a response indicating whether the user terminal is included in a predetermined area, and since it employs an expression based on a space-filling curve, it can quickly determine the inclusion relationship. Since the network node according to this aspect can quickly determine the location inclusion relationship, it can be used particularly effectively in location information services that target a large number of user terminals.

In this aspect, the predetermined area is expressed as a bit string based on a space-filling curve in the inquiry request, and whether the user terminal is located in the predetermined area may be confirmed by comparing a bit string included in the inquiry request with the stored bit string. For example, comparing location information bit strings representing the location of a predetermined area and the user terminal starting from the upper bits, and when the bit string representing the predetermined area matches the upper bit string of the user terminal location, it can be determined that the user terminal location is included in the predetermined area; otherwise, it can be determined that the user terminal location is not included.

In this aspect, the predetermined area may be a combination of a plurality of rectangles, and the inquiry request may include a bit string expressing each of the plurality of rectangles based on a space-filling curve. Since the predetermined area is represented as a combination of a plurality of rectangular areas, any shape can be represented. The sizes of the respective rectangular areas are not particularly limited and may be different from each other. Also, since it is possible to determine whether a user terminal is included in each rectangular area as described above, similarly, it is possible to quickly determine whether a user terminal is included in a predetermined area that is a combination of these rectangular areas.

Another aspect of the present disclosure relates to an information processing system including a network node, and a client, where the client transmits an inquiry request for location information of a user terminal to the network node, the network node transmits a response including location information of the user terminal to the client in response to the inquiry request, and the location information included in the response is expressed by a bit string based on a space-filling curve.

Still another aspect of the present disclosure relates to an information processing method that is executed by a network node forming a wireless communication network, the information processing method including receiving an inquiry request for location information of a user terminal (UE), and transmitting a response including location information of the user terminal in response to the inquiry request, where the location information included in the response is expressed by a bit string based on a space-filling curve.

The present disclosure further includes a computer program that causes a computer to execute each step of the method, and a computer program that realizes the network node or information processing system by a computer. The present disclosure further includes a computer readable medium having the computer program recorded thereon.

An example of a wireless communication network in the present disclosure is a system that utilizes 5G, 4G, LTE, LTE-A, SUPER 3G, IMT-Advanced, NR, or the like, and next-generation systems enhanced based on these. Also, other examples of wireless communication networks are IEEE 802.11 (Wi-Fi (registered trademark)), IEEE 802.16 (WiMAX (registered trademark)), IEEE 802.20, UWB, Bluetooth (registered trademark), and other systems and next generation systems enhanced based on these. A wireless communication network may be a combination of a plurality of systems.

### First Embodiment

An embodiment of the present disclosure will be described below based on the drawings. The following embodiment is merely an illustrative example, and the present disclosure is not limited to the configurations of the embodiment. An example of wireless communication networks to which the present disclosure is applicable is a system that utilizes 5G, 4G, LTE, LTE-A, SUPER 3G, IMT-Advanced, NR, or the like, and next-generation systems expanded based on these. Further, other examples of wireless communication networks to which the present disclosure is applicable are IEEE 802.11 (Wi-Fi (registered trademark)), IEEE 802.16 (WiMAX (registered trademark)), IEEE 802.20, UWB, Bluetooth (registered trademark), other systems, and next-generation systems extended based on these. A wireless communication network to which the present disclosure is applied may be a system in which a plurality of systems is combined.

### Configuration of Information Processing System

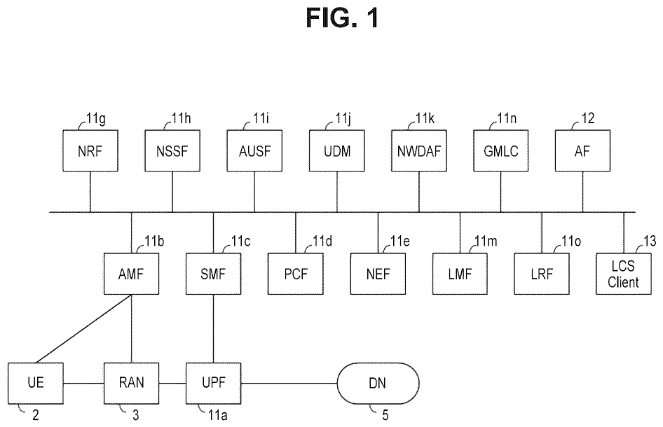

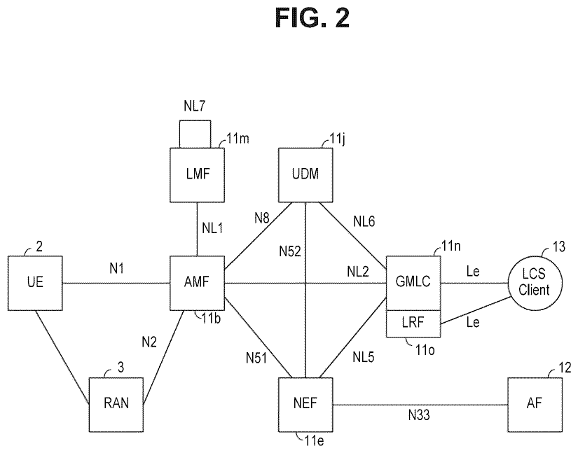

FIGS. 1 and 2 illustrate components that constitute a fifth generation mobile communication system (5G network). FIG. 1 is a diagram illustrating an overview of a service-based architecture (SBA) in 5G, and FIG. 2 is a diagram illustrating an architecture based on a reference point expression regarding Location Service in 5G.

In the figure, User Equipment (UE) 2 is a user (subscriber) terminal. Radio Access Network (RAN) 3 is an access network to the 5G core network (5GC). RAN 3 is configured by base stations (gNB). The 5G network includes a 5G core network (5GC) and an access network ((R)AN), and a UE 2, a DN 5, and an AF 12 are connected to the 5G network. Each of NFs 11a to 11o is a function realized by one or more computers (information processing devices) executing a program. However, a single computer may implement any two or more of the NFs 11a to 11o. Each of the NFs 11a to 11o may also be referred to as a network node or network component.

The 5GC is configured by a set of components having a predetermined function called a Network Function (NF). In FIG. 1, the following are illustrated as the NFs 11 constituting the 5GC.
User Plane Function (UPF) 11a
Access and Mobility Management Function (AMF) 11b
Session Management Function (SMF) 11c
Policy Control Function (PCF) 11d
Network Exposure Function (NEF) 11e
Network Repository Function (NRF) 11g
Network Slice Selection Function (NSSF) 11h
Authentication Server Function (AUSF) 11i
Unified Data Management (UDM) 11j
Network Data Analytics Function (NWDAF) 11k
Location Management Function (LMF) 11m
Gateway Mobile Location Center (GMLC) 11n
Location Retrieval Function (LRF) 11o

The UPF 11a performs routing and forwarding of user packets (user plane packets transmitted and received by the UE 2), packet inspection, and QoS processing.

The AMF 11b is a UE 2 accommodating device in the 5GC. The AMF 11b accommodates the RAN 3 and performs subscriber authentication control, location (mobility) management of the UE 2, and the like.

The SMF 11c manages Protocol Data Unit (PDU) sessions and controls the UPF 11a to implement Quality of Service (QOS) control and policy control. The PDU session is a virtual communication channel for exchanging data between the UE 2 and a Data Network (DN) 5. The DN 5 is a data network (such as the Internet) outside the 5GC.

The PCF 11d performs QoS control, policy control, billing control, and the like under the control of the SMF 11c. In the QoS control, communication quality control such as priority transfer of packets is performed. In the policy control, communication control such as QoS, packet transfer availability, and billing is performed based on network or subscriber information.

The NEF 11e serves to mediate communication between external nodes and nodes in the control plane.

The NRF 11g stores and manages information on NFs (for example, AMF, SMF, UPF, and the like) within the 5GC. In response to an inquiry regarding the NF desired for use, the NRF 11g can reply to an inquiry source with a plurality of NF candidates.

The NSSF 11h has a function of selecting a network slice for use by a subscriber from among network slices generated by network slicing. A network slice is a virtual network that has specifications depending on its purpose.

The AUSF 11i is a subscriber authentication server that performs subscriber authentication under the control of the AMF 11b.

The UDM 11j maintains subscriber-related information, provides subscriber information, or acquires, registers, deletes, and changes the state of the UE 2.

The NWDAF 11k has a function of collecting and analyzing data from each NF 11, an OAM terminal 8 (FIG. 2), an external server, and the like. It is an NF that provides network analysis information.

The LMF 11m manages the overall coordination and scheduling of resources required for location determination of the UEs registered with or accessing the 5GC. The LMF 11m may also calculate or verify the final location and velocity estimates of the UE and estimate the achieved accuracy. The LMF 11m receives a target UE location request from a serving AMF using the Nlmf interface. The LMF 11m interacts with the UE to exchange location information applicable to UE assistance and UE-based positioning methods and interacts with the RAN or the like to acquire location information. The LMF 11m expresses the result of the UE location determination in a predetermined expression format. The LMF 11m may determine the expression format of the location information based on the type of LCS client, supported formats, or the like, upon receiving the location request.

The GMLC 11n includes a function necessary to support the Location Service. The GMLC 11n is the node that the LCS client 13 accesses first. The GMLC 11n acquires the target UE's routing information and privacy information from the UDM and transmits a location request to the serving AMF after the privacy is confirmed. The GMLC 11n also allows the NF to request location determination of the UE.

The LRF 11o is responsible for retrieval or validation of location information. The LRF 11o may be co-located with the GMLC 11n or may be arranged separately.

The AF 12 is either an NF that is part of the 5GC and provides application services via the NRF 11g, or an NF that is external to the 5GC and provides application services via the NEF 11e. The AF 12 accesses the LCS services from the GMLC 11n within the same trust domain (for example, within the same PLMN) using, for example, the Ngmlc interface to provide services based on the acquired location information.

The Location Service (LCS) client 13 accesses the LCS service from the GMLC 11n using the Le reference point and provides a service based on the acquired location information. The LCS client 13 may reside within the UE 2.

In the 5GC, a plurality of NFs of the same type may be prepared. For example, the NF 11 may be prepared for each data center (building). Further, one NF 11 may be shared between data centers. Also, a plurality of NFs 11 of the same type may be configured in one data center. The number of data centers and the number of NFs 11 can be set as appropriate based on the correspondence relationship between NFs 11 and data centers.

The LMF 11m receives a request from the LCS client 13 or the AF 12 to inquire about the location information of a target UE and transmits the location information of the UE as a response. Here, the location information provided by the LMF 11m can be expressed as a bit string based on a space-filling curve. Examples of space-filling curves may include Hilbert curves or Z-order curves. In the present disclosure, location information expressed in a bit string based on a space-filling curve is also referred to as “location information expressed in a location code” or simply “location code”. Further, the LMF 11m may receive an inquiry from the LCS client 13 or the AF 12 as to whether a target UE is included in a predetermined area and may transmit the result as a response.

### Configuration of Information Processing Device and Terminal

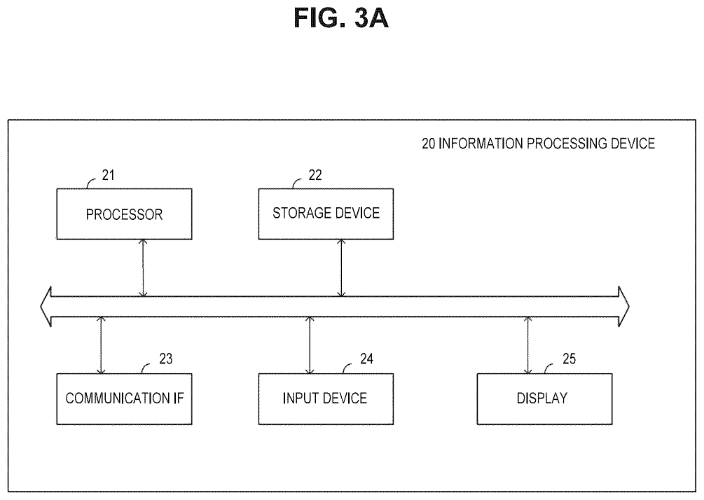

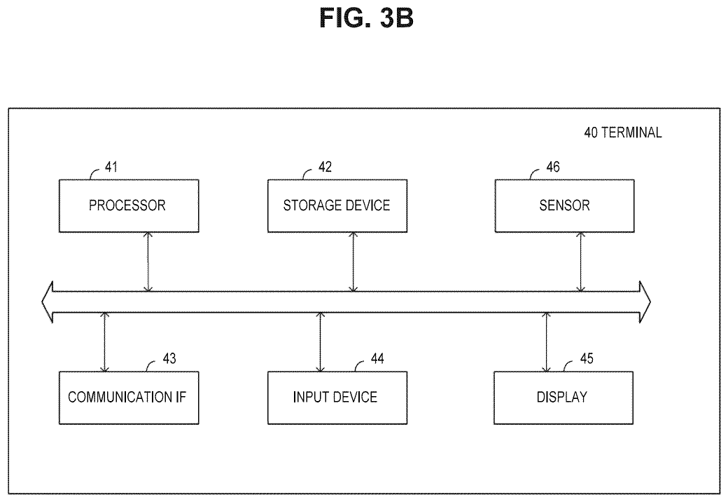

FIG. 3A is a diagram illustrating a configuration example of an information processing device that can operate as each of the NFs 11a to 11o, the OAM terminal, and the external server. In FIG. 3A, an information processing device 20 can be configured using a dedicated or general-purpose information processing device (computer) such as a personal computer (PC), a workstation (WS), or a server machine. However, the information processing device 20 may be a collection (cloud) of one or more computers.

The information processing device 20 includes a processor 21 as a processing unit or a controller, a storage device 22, a communication device 23, an input device 24, and a display 25, which are interconnected via a bus.

The storage device 22 includes a main storage device and an auxiliary storage device. The main storage device is used as at least one of a storage area for programs and data, a development area for programs, a work area for programs, and a buffer area for communication data. The main storage device is composed of a Random Access Memory (RAM) or a combination of a RAM and a Read Only Memory (ROM). The auxiliary storage device is used as a storage area for data and programs. A nonvolatile storage medium is applied to the auxiliary storage device. Examples of the nonvolatile storage medium include a hard disk, a solid state drive (SSD), a flash memory, and an Electrically Erasable Programmable Read-Only Memory (EEPROM). Further, the storage device 22 can include a drive device for a disk recording medium.

The communication device 23 is a circuit that performs communication processing. For example, the communication device 23 is a network interface card (NIC). Further, the communication device 23 may be a wireless communication circuit that performs wireless communication (5G, wireless LAN (Wi-Fi (registered trademark)), BLE, or the like). Further, the communication device 23 may be a combination of a circuit that performs wired communication processing and a wireless communication circuit.

The input device 24 includes keys, buttons, pointing devices, touch panels, and the like, and is used to input information. The display 25 is, for example, a liquid crystal display, and displays information and data.

The processor 21 performs various processes by executing various programs stored in the storage device 22. By the processor 21 executing the program stored in the storage device 22, the information processing device 20 can operate as each of the NFs 11a to 11k, the OAM terminal 8, and external servers 12a and 12b.

FIG. 3B is a diagram illustrating a configuration example of a terminal 40 that can operate as the UE 2. The terminal 40 includes a processor 41, a storage device 42, a communication device 43, an input device 44, a display 45, and a sensor 46, which are interconnected via a bus. The processor 41, the storage device 42, the communication device 43, the input device 44, and the display 45 can be similar to the processor 21, the storage device 22, the communication device 23, the input device 24, and the display 25. For this reason, these descriptions will be omitted.

The processors 21, 41 are, for example, Central Processing Units (CPUs). The CPU is also called a Microprocessor Unit (MPU). The processors 21, 41 may have a single processor configuration or a multiprocessor configuration. Further, a single physical CPU connected through a single socket may have a multi-core configuration. The processors 21, 41 may include arithmetic devices with various circuit configurations, such as a Digital Signal Processor (DSP) or a Graphics Processing Unit (GPU). Further, the processors 21, 41 may have a configuration that cooperates with at least one of an integrated circuit (IC), other digital circuit, and analog circuit. Integrated circuits include LSIs, application specific integrated circuits (ASICs), programmable logic devices (PLDs), and the like. The PLDs include, for example, a Field-Programmable Gate Array (FPGA). The processors 21, 41 include, for example, what is called a microcontroller (MCU), an System-on-a-chip (SoC), a system LSI, or a chipset.

Examples of the sensor 46 are sensors for measuring the external environment of the UE 2, such as a radar sensor such as a millimeter wave radar, a Light Detection and Ranging (LiDAR) sensor, an ultrasonic sensor, an image sensor, an acoustic sensor, a positioning sensor, an illuminance sensor, a rain sensor, a temperature sensor, and a humidity sensor. Other examples of the sensors 46 are speed sensors, acceleration sensors, and sensors that measure the internal state of the UE 2. The sensors listed here are merely exemplary, and the present disclosure includes any sensor. An example of the sensor 46 is a Global Navigation Satellite System (GNSS) positioning device such as a GPS device.

### Operation Example: Location Service

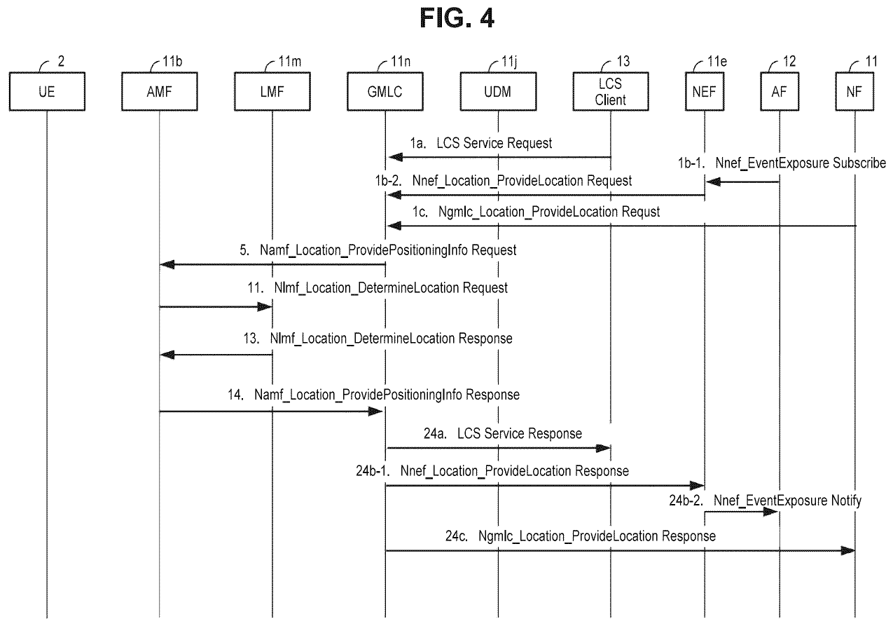

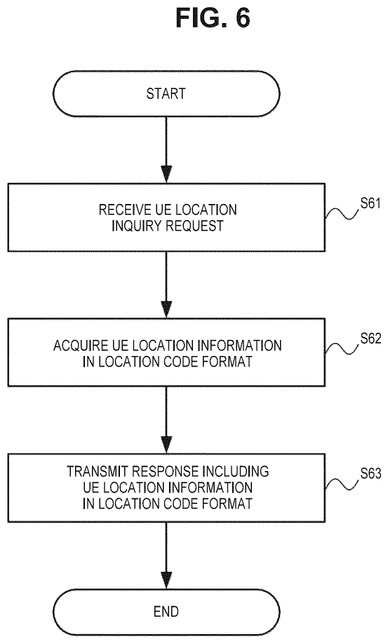

FIG. 4 illustrates a 5GC Mobile Terminated Location Request (5GC-MT-LR) procedure for a commercial location service as an example of the location service. FIG. 4 is an excerpt from FIG. 6.1.2-1 (5GC-MT-LR procedure for commercial location service) of TS23.273 v18.1.0, and the process numbers correspond to the numbers in the figure. The process of FIG. 4 is only an example, and the present disclosure is also applicable to a regulatory location service and a 5GC Mobile Originated Location Request (5GC-MO-LR) procedure, or other procedures.

In step 1a or 1c, the LCS client 13 or NF 11 transmits a location request for a target UE 2 to the GMLC 11n. In step 1b (1b-1 and 1b-2), the AF 12 transmits a location request for the target UE 2 to the GMLC 11n via the NEF 11e. These requests are referred to as LCS requests in the present disclosure. The LCS request may optionally include a request for speed of the target UE. The LCS request may also include required QoS, supported expression formats and shapes of location information, and other attributes. The LCS request may include a service ID, a codeword, and service coverage information.

The GMLC 11n that received the LCS request acquires the privacy settings of the UE 2 from the UDM 11j and confirms the LCS privacy profile. When locating the target UE 2 is permitted, the GMLC 11n performs the following processing. The GMLC 11n also acquires the network address of the AMF 11b currently providing service from the UDM 11j.

In step 5, the GMLC 11n calls the Namf_Location_ProvidePositioningInfo service operation to the AMF 11b to request the current location of the target UE 2. When the UE 2 is in an idle state, the AMF 11b initiates a network-triggered service request procedure to establish a signaling connection with the UE 2 and perform privacy verification if necessary.

In step 11, the AMF 11b calls the Nlmf_Location_DetermineLocation service operation on the LMF 11m to request the current location of the target UE 2. The service operation includes an LCS Correlation identifier, a serving cell identifier of the primary cell in the master RAN node, a serving cell identifier of the primary cell in the secondary RAN in a Dual Connectivity (DC) scenario, and a client type. The service operation may include information on the expression format and shape of location information supported by the UE 2.

In step 13, the LMF 11m performs a location determination procedure for the target UE 2 and returns a Nlmf_Location_DetermineLocation Response including the determined current location of the UE 2 to the AMF 11b. In step 14, the AMF 11b returns a Namf_Location_ProvidePositioningInfo Response including the current location of the target UE 2 to the GMLC 11n. The GMLC 11n performs privacy verification again as necessary, and then returns location service responses to the LCS client 13, AF 12, and NF 11 in steps 24a, 24b (24b-1, 24b-2), and 24c.

### Message and Parameter

The service operation in the Nlmf_Location service includes a DetermineLocation service operation that provides UE location information to a service request source such as the LCS client 13. The DetermineLocation Request (location inquiry request) may include information about an external client type, an LCS correlation identifier, a serving cell identifier, a location QoS, and supported data formats and shapes, for example. Examples of supported data formats are an expression format using latitude/longitude/altitude and a location code expression format based on space-filling curves. Examples of supported shapes are collections of points, points with uncertainties, circles, ellipses, polygons, and rectangles.

When the location information of the target UE is successfully acquired, the LMF 11m returns a DetermineLocation Response including location data as a response to the DetermineLocation Request. In one embodiment, the response includes location information expressed in a location code based on a space-filling curve. Here, a bit string expression of location information based on a space-filling curve will be described.

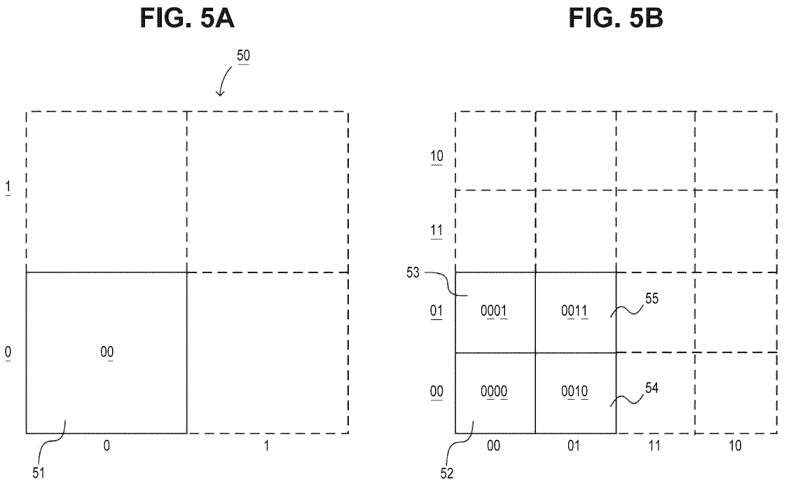

FIGS. 5A and 5B are diagrams for illustrating a bit string expression (in other words, a method of generating a location code) of location information based on a space-filling curve. The location code expresses the location as a rectangle with a predetermined range. Specifically, a first bit string that specifies the location in a latitude direction (first direction) and a second bit string that specifies the location in a longitude direction (second direction) are defined, and then a rectangular area is designated by a combination of these bits.

The example in FIG. 5A is an example in which an entire area 50 is divided into two in the latitude and longitude directions to define a total of four areas. Since the latitude and longitude directions are divided into two, the bit string expressing the location in the latitude and longitude directions has a length of 1 bit, respectively. For example, an area 51 is expressed by two bits, for example, “00”, which is a combination of a bit “0” expressing the location in the latitude direction and a bit “0” in the longitude direction.

The example in FIG. 5B is an example in which the entire area 50 is divided into four in the latitude and longitude directions to define a total of 16 areas. Since the latitude and longitude directions are divided into four, the bit string expressing the location in the latitude and longitude directions has a length of 2 bits. Here, in FIG. 5B, since the division in FIG. 5A is subdivided, the bit string specifying the latitude and longitude directions is created by adding 1 bit to the bit string in FIG. 5A. Each of areas 52 to 55 in FIG. 5B is expressed by a bit string in which a bit string expressing the latitude direction and a bit string expressing the longitude direction are alternately arranged. For example, the area 53 is expressed as “0001” by alternately arranging a bit string “00” specifying the longitude direction and a bit string “01” specifying the latitude direction. In FIG. 5A and FIG. 5B, for the sake of description, the bit string specifying the latitude direction is shown with an underline added.

Since the location code is determined based on such rules, the area (rectangle) expressed by the location code has a width corresponding to the number of bits of the location code. Specifically, the smaller the number of bits, the wider the area, and the larger the number of bits, the narrower the area. Further, each time the division layer increases by one level, the area size becomes one-fourth and the location code increases by 2 bits. The upper layer area (for example, area 51) is an area that is equal to the sum of the lower layer areas (for example, areas 52 to 55).

Although a two-dimensional location code is described here, a location and area in a three-dimensional space can be expressed based on a three-dimensional space-filling curve to which altitude is added. In the present disclosure, the three-dimensional location of the UE may be expressed in a location code format, or the three-dimensional location of the UE may be expressed in a combination of a two-dimensional location code format and altitude.

Further, the upper bits of the location code of the lower layer area included in the upper layer area are equal to that of the location code of the upper layer area. For example, the upper two bits of each of the areas 52 to 55 are equal to the location code “00” of the area 51 in the upper layer that includes these areas. Therefore, according to such a code expression, the inclusion relationship between areas can be easily determined by comparing bit strings, in other words, by simply performing bit logical operations. Confirming the inclusion relationship through the determination of a match in upper bits can be applied when conducting area comparisons between arbitrary layers.

The LMF 11m includes the location information of the UE 2 expressed in the location code as described above in the text of the DetermineLocation Response and transmits it to the AMF 11b. In other cases, the LMF 11m may transmit location information in other expression formats such as a latitude/longitude/altitude format to the AMF 11b.

### Operation Example of LMF 11m

FIG. 6 is a flowchart illustrating processing that the LMF 11m performs in response to a location inquiry request. In step S61, a location inquiry request of the target UE 2 is received. In step S62, the LMF 11m acquires UE location information in the location code format of the target UE 2. In step S63, the LMF 11m creates a response including the UE location information in the location code format and transmits it to a location inquiry requester.

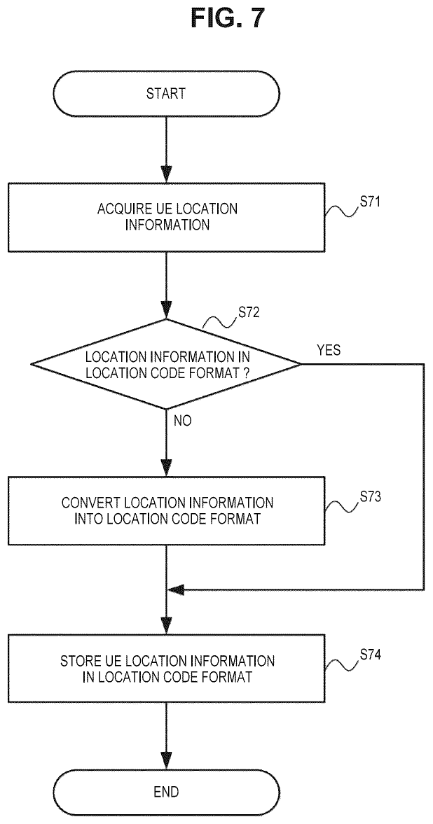

FIG. 7 is a flowchart illustrating processing related to acquisition and storage of UE location information performed by the LMF 11m in step S62.

In step S71, the LMF 11m acquires UE location information. The method that acquires the UE location information is not particularly limited, and the location may be determined using the RAN 3, or the location may be determined using a sensor (positioning device) that the UE 2 has itself. Alternatively, the LMF 11m may acquire the UE location information by requesting it from other NFs. The expression format of the location information acquired by the LMF 11m may be arbitrary, and may be, for example, a latitude/longitude/altitude format or a location code expression format based on a space-filling curve.

In step S72, the LMF 11m determines whether the acquired location information is in a location code expression format based on a space-filling curve. When the acquired location information is in the location code format, the processing proceeds to step S74; otherwise, the processing proceeds to step S73. When the expression format of the location information acquired by the LMF 11m is predetermined or can be known in advance, determination processing in step S72 may be omitted.

In step S73, the LMF 11m converts the location information into a location code format. Location code format conversion processing can be performed by determining which rectangular area in the location code expression format the location information expressed in another expression format (for example, latitude/longitude/altitude expression) belongs to, and outputting a location code expressing the rectangular area. The number of bits of the location code to be output may be fixed in advance, or when the accuracy or uncertainty of the acquired location information is clear, the number of bits may be determined according to the accuracy or uncertainty.

In step S74, the LMF 11m stores the thus obtained UE location information in the location code format in the storage device.

The LMF 11m executing the processing shown in FIG. 6, more specifically, the LMF 11m returning a response (13.Nlmf_Location_DetermineLocation Response) including UE location information in the location code form in response to a location inquiry request (11.Nlmf_Location_DetermineLocation Request in FIG. 4), corresponds to a “network node” in the present disclosure. However, since the Namf_Location_ProvidePositioningInfo Response returned by the AMF 11b also includes UE location information in the location code format, the AMF 11b also corresponds to a “network node” in the present disclosure. Similarly, since the responses (processes 24a to 24c in FIG. 4) that the GMLC 11n returns to the LCS client 13, AF 12, and NF 11 also include UE location information in the location code form, the GMLC 11n also corresponds to a “network node” in the present disclosure.

### Other Requests

The above-described location inquiry request is described as a request (ImmediateLocation Request) for the current location of the target UE. However, the location inquiry request in the LCS Service may be a future location request (DeferredLocation Request) that may occur based on an event. Examples of triggering events include events related to UE availability, changes in area affiliation, periodic reporting, and UE movement.

Examples of area change events include the UE leaving a predetermined area, the UE entering a predetermined area, and the UE currently located in a predetermined area. In order to respond to such event-based UE location inquiry requests, the LMF 11m converts and stores a predetermined area included in the request into a location code format based on a space-filling curve. The LMF 11m determines whether the UE location is included in a predetermined area by comparing the upper bits of the location code of the UE location and the predetermined area. Even when the overhead for converting a predetermined area into the location code format is taken into account, it is expected that the overall processing efficiency will be improved because it becomes easier to determine the inclusion relationship.

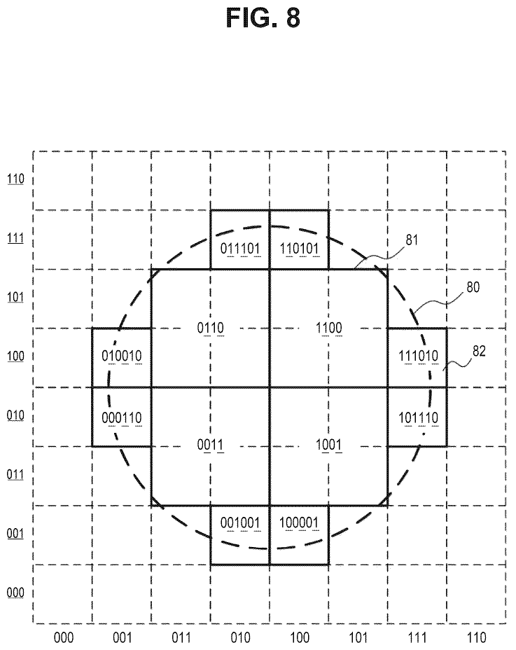

FIG. 8 is a diagram illustrating an example in which a circular area 80 is expressed in a location code format, as an example of expressing an area of an arbitrary shape in a location code. This example shows that the circular area 80 indicated by a broken line can be expressed by a combination of four rectangular areas 81 expressed in 4 bits and eight rectangular areas 82 expressed in 6 bits. In this way, an area of an arbitrary shape can be expressed by listing bit strings expressing a plurality of rectangular areas. The description of FIG. 8 shows an outline, and the number of bit strings expressing each rectangular area may be larger.

In order to determine the inclusion relationship between the area expressed in the location code format and the location of the UE in this way, the inclusion relationship between each rectangular area constituting the area and the UE location may be determined by comparing the upper bits, and it may be determined whether the UE location is included in any of the rectangular areas. Since the determination of the inclusion relationship is a simple process of comparing (bit OR operation) bit strings, the processing allows for quick determination even when dealing with a large number of rectangles that form the area.

Further, in addition to or instead of a request for UE location information, the location inquiry request may include a confirmation request as to whether the UE is located in a predetermined area. The “predetermined area” may be expressed in the latitude/longitude format or GAD format in the location inquiry request or may be expressed in the location code format. When the predetermined area is expressed in the latitude/longitude format or GAD format, the LMF 11m converts the information into a location code format, and then determines the inclusion relationship with the UE location. The relationship determination of the present application can be made by comparing the upper bits of the location code expressing the area and the location code expressing the UE location, as described above. Moreover, when the predetermined area is expressed by a plurality of areas, the inclusion relationship with the UE location may be determined for each area.

The predetermined area may be included in the location inquiry request by the LCS client 13 (or the AF 12, the NF 11) in the location code format, or the format may be converted by any NF of the GMLC 11n, the AMF 11b, and the LMF 11m, or another NF.

### Advantageous Effects of this Embodiment

With this embodiment, since the location of the UE is expressed in the location code format based on a space-filling curve, it is possible to determine whether the terminal location is included in the designated area by logical operations, and thus quick determination is possible. Further, expression in the location code format also has an advantage of being able to flexibly express an area of an arbitrary shape.

### Other Modification Examples

The embodiment described above is a mere example, and the present disclosure may be implemented with appropriate changes within the scope of the gist thereof.

The present disclosure can also be realized by supplying a computer program implementing the functions described in the embodiments to a computer and having one or more processors included in the computer read and execute the program. Such a computer program may be provided to the computer by a non-transitory computer-readable storage medium connectable to a system bus of the computer or may be provided to the computer via a network. The non-transitory computer-readable storage medium includes, for example, any type of disk, such as a magnetic disk (floppy (registered trademark) disk, hard disk drive (HDD), and the like), and an optical disks (CD-ROM, DVD disk, Blu-ray disk, and the like), a read-only memory (ROM), a random access memory (RAM), an EPROM, an EEPROM, a magnetic card, a flash memory, an optical card, or any type of medium suitable for storing an electronic instruction.

What is claimed is:

1. A network node that forms a wireless communication network, the network node comprising:
a processor configured to:
receive an inquiry request for location information of a user terminal (UE); and
transmit a response including the location information of the user terminal in response to the inquiry request, wherein
the location information included in the response is expressed by a bit string based on a space-filling curve.

2. The network node according to claim 1, wherein the location information included in the response is expressed by a bit string based on a Hilbert curve or a Z-order curve.

3. The network node according to claim 1, wherein the location information included in the response represents an area and has the number of bits depending on size of the area.

4. The network node according to claim 1, wherein the location information included in the response is expressed by a bit string in which a first bit string specifying a first direction and a second bit string specifying a second direction are arranged alternately.

5. The network node according to claim 1, wherein the processor is configured to:
acquire location information from the user terminal; and
store the location information of the user terminal in a bit string format based on a space-filling curve.

6. The network node according to claim 5, wherein
the inquiry request includes a request for confirmation as to whether the user terminal is located in a predetermined area,
the response includes information as to whether the user terminal is located in the predetermined area, and
the processor is configured to confirm whether the user terminal is located in the predetermined area by comparing a bit string based on a space-filling curve representing the predetermined area with the stored bit string based on a space-filling curve.

7. The network node according to claim 6, wherein
the predetermined area is expressed as a bit string based on a space-filling curve in the inquiry request, and
whether the user terminal is located in the predetermined area is confirmed by comparing a bit string included in the inquiry request with the stored bit string.

8. The network node according to claim 7, wherein
the predetermined area is an area that combines a plurality of rectangles, and
the inquiry request includes a bit string expressing each of the rectangles based on a space-filling curve.

9. The network node according to claim 6, wherein
the predetermined area is expressed in a latitude/longitude format or a Geographical Area Description (GAD) format in the inquiry request, and
the processor is configured to convert a predetermined area included in the inquiry request into a bit string based on a space-filling curve.

10. An information processing system comprising:
a network node; and
a client, wherein
the client is configured to transmit an inquiry request for location information of a user terminal to the network node,
the network node is configured to transmit a response including the location information of the user terminal to the client in response to the inquiry request, and
the location information included in the response is expressed by a bit string based on a space-filling curve.

11. The information processing system according to claim 10, wherein the location information included in the response is expressed by a bit string based on a Hilbert curve or a Z-order curve.

12. The information processing system according to claim 10, wherein the client is configured to determine whether the user terminal is located in a predetermined area by comparing a bit string based on a space-filling curve included in the response with a bit string that expresses the predetermined area based on a space-filling curve.

13. An information processing method that is executed by a network node forming a wireless communication network, the information processing method comprising:
receiving an inquiry request for location information of a user terminal (UE); and
transmitting a response including the location information of the user terminal in response to the inquiry request, wherein
the location information included in the response is expressed by a bit string based on a space-filling curve.

14. A non-transitory storage medium storing instructions that are executable by one or more processors in a computer and that cause the one or more processors to perform the information processing method according to claim 13.
